(19) United States
(12) Patent Application Publication
(10) Pub. No.: US 2003/0052783 A1
(43) Pub. Date: Mar. 20, 2003

(54) Dock door RFID system

(76) Inventor: William B. Sitzman, N. Tonawanda, NY (US)

Correspondence Address: NIXON & VANDERHYE P.C., 8th Floor, 1100 North Glebe Road, Arlington, VA, 22201, US

(21) Appl. No.: 09/953,446

(22) Filed: Sep. 17, 2001

(51) Int. Cl. G08B 13/14

(52) U.S. Cl. 340/572.7; 340/572.1

(57) ABSTRACT

An RFID antenna system for providing an interrogation zone over a width of a dock bay door comprises a horizontally arranged array of antennas, each of the antennas being substantially coplanar with all of the other antenna(s), and a circuit operatively coupled to the array for providing a respective signal to each of the antennas to enable each of the antennas to emit an interrogation field. The interrogation fields emitted from the respective antennas jointly form an interrogation zone in a volume positioned above each of the antennas. Each of the antennas is mounted on, within or beneath a portion of the floor which is close to the dock bay door.

### BACKGROUND OF THE INVENTION

1. Field of the Invention

The present invention relates to an antenna arrangement for a radio frequency identification (RFID) system. More specifically, the present invention relates to a horizontally mounted antenna array for defining an RFID interrogation zone that spans the entire width of a dock bay door.

2. Background of Related Art

The use of an RFID system to identify and monitor objects is well known in the art. FIG. 1 illustrates a gated antenna array that is used as part of a conventional RFID system. The antenna array includes vertically mounted antennas 10a, 10b, each of which respectively produces and emits a magnetic interrogation field 12a, 12b at a specific frequency when excited by electronic circuitry (not shown). The interrogation fields 12a, 12b together form an interrogation zone. If an RFID transponder is positioned within the interrogation zone for a sufficient time, it will become stimulated and transmit a uniquely coded signal that is received by the antennas 10a,10b or a separate receiving antenna.

The transponder can be either an active transponder or a passive transponder. An active transponder has its own internal battery, whereas a passive transponder does not have its own internal battery and generates its required power through inductive coupling to an interrogation field. Passive transponders are generally less expensive than active transponders. However, one drawback of RFID systems which include passive transponders is its relatively limited read range, (i.e., relatively limited interrogation zone). For example, the interrogation fields 12a, 12b emitted by vertically mounted antennas 10a, 10b provide an interrogation zone that is only five feet wide (distance “a” in FIG. 1) for stimulating a 4 inch×6 inch transponder with a 13.56 MHz frequency band.

The depth of an interrogation zone is a function of the antenna dimensions. The depth required to effectively identify a transponder is determined by the speed of the transponder passing through the interrogation zone and the interrogation time required by the RFID system. A conventional RFID system requires approximately 100 msec to interrogate a transponder and receive the coded signal from the transponder. This interrogation time includes a redundancy reading to increase the probability that the transponder will be read correctly. If the transponder is moving at 10 mph or 14.7 fps, the depth of the interrogation zone must be at least 1.5 feet.

One specific application of an RFID system is to identify and monitor objects entering or leaving a warehouse. Since objects entering and leaving the warehouse will each pass through a dock bay door (or at least one of the dock bay doors), the dock bay door is an effective place to implement an RFID system. A dock bay door, however, is typically about 12 feet in width. Conventional RFID systems using passive transponders such as the one illustrated in FIG. 1 cannot therefore effectively provide an interrogation zone which spans the entire width of the dock bay door.

Accordingly, there remains a need for a solution to this problem. That is, there remains a need to overcome the inability of conventional RFID systems, particularly those using passive transponders, to provide an interrogation zone that spans the width of a dock bay door.

### SUMMARY OF THE INVENTION

The present invention overcomes or alleviates the above problems. In one exemplary embodiment of the invention, an RFID antenna system for providing an interrogation zone comprises an antenna array including a plurality of coplanar antennas and a circuit for providing a respective signal to each of the antennas of the array to enable each of the antennas to emit an interrogation field. The interrogation fields emitted from the respective antennas together form the interrogation zone in a volume positioned above each of the antennas.

One or more pairs of the plurality of antennas may be connected in parallel to each other. The circuit comprises a first impedance matching circuit operatively coupled to a first antenna or first parallel-connected pair of antennas and a second impedance matching circuit operatively coupled to a second antenna or second parallel-connected pair of antennas.

In some exemplary embodiments, the circuit further comprises a first reader circuit operatively coupled to the first impedance matching circuit for providing an output signal to the first impedance matching circuit and a second reader circuit operatively coupled to the second impedance matching circuit for providing an output signal to the second impedance matching circuit. Alternatively, the circuit further comprises a reader circuit operatively coupled to the first impedance matching circuit and the second impedance matching circuit for providing output signals to both the first impedance matching circuit and the second impedance matching circuit.

The antennas of the antenna array may be mounted within a portion of a floor, on top of a portion of the floor or underneath a portion of the floor. In those embodiments in which the antenna array is mounted within a portion of the floor, a side of at least one of the antennas may be flush with the surface of the floor. The portion of the floor in, on or underneath which the antennas are mounted is proximate to a door such as a dock bay door so that the interrogation zone is formed over the width of the door.

In another exemplary embodiment of the invention, method (and system) of providing an interrogation zone for an RFID system over a width of a door and above a portion of a floor proximate to the door comprises arranging an antenna array so that each of a plurality of antennas in the array is arranged parallel to the floor and providing a respective signal to each of the antennas of the array to enable each of the antennas to emit a respective interrogation field. The interrogation fields emitted from the respective antennas jointly form an interrogation zone in a volume which is above each of the antennas and the floor. The antennas of the antenna array may be mounted within a portion of a floor, on top of a portion of the floor or underneath a portion of the floor. If the antenna array is mounted within a portion of the floor, a side of at least one of the antennas may be flush with the surface of the floor. Each of the antennas may be substantially coplanar with all of the other antenna(s) and at least one pair of the plurality of antennas may be connected in parallel to each other.

### BRIEF DESCRIPTION OF THE DRAWINGS

These, as well as other objects and advantages of this invention, will be more completely understood and appreciated by careful study of the following more detailed description of the presently preferred exemplary embodiments of the invention taken in conjunction with the accompanying drawings, in which:

FIG. 1 is a cross-sectional view of a conventional antenna array of an RFID system;

FIG. 2 is a cross-sectional view of an antenna array of an RFID system in accordance with an exemplary embodiment of the present invention;

FIG. 3 is a top view of an antenna array of an RFID system in accordance with an exemplary embodiment of the present invention;

FIG. 4A is an electronic schematic diagram illustrating a lumped element model of a conventional single loop antenna;

FIG. 4B is an electronic schematic diagram illustrating a lumped element model of a portion of the antenna array of an RFID system in accordance with an exemplary embodiment of the present invention;

FIG. 5 is a diagram of RFID antenna system in accordance with an exemplary embodiment of the present invention;

FIG. 6 is a diagram of RFID antenna system in accordance with another exemplary embodiment of the present invention;

FIG. 7 is an electronic schematic diagram of a matching circuit that is capable of being implemented in the RFID antenna system of the present invention;

FIG. 8 is an electronic schematic diagram of another matching circuit that is capable of being implemented in the RFID antenna system of the present invention;

FIG. 9 is a cross-sectional view of an antenna array of an RFID system that has been mounted on a floor in accordance with an exemplary aspect of the present invention;

FIG. 10 is a cross-sectional view of an antenna array of an RFID system that has been mounted into a floor in accordance with another exemplary aspect of the present invention; and

FIG. 11 is a cross-sectional view of an antenna array of an RFID system that has been mounted underneath a floor in accordance with another exemplary aspect of the present invention.

### DETAILED DESCRIPTION OF THE INVENTION

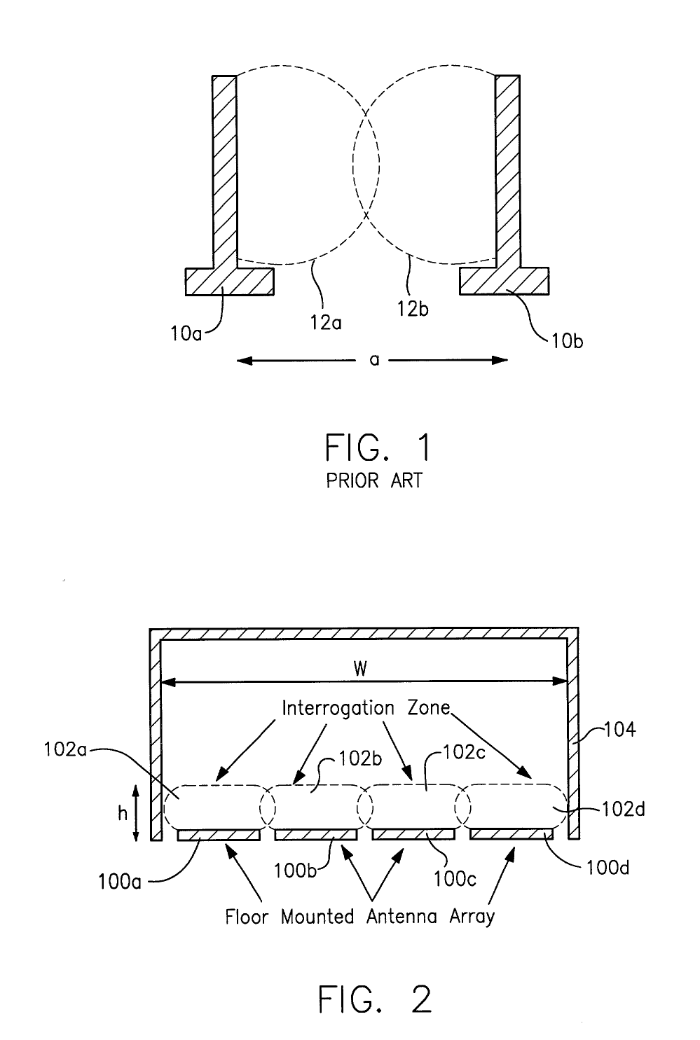

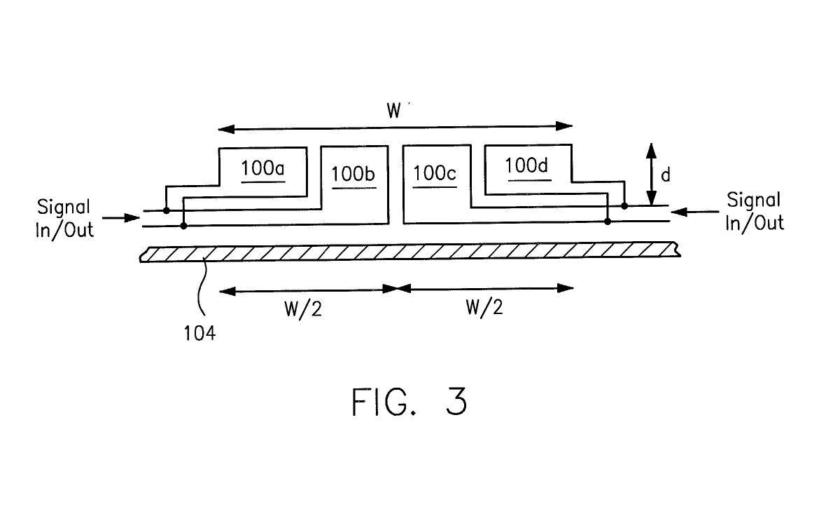

FIGS. 2 and 3 illustrate a cross-sectional view and a top view, respectively, of an antenna array of an RFID system in accordance with an exemplary embodiment of the present invention. The antenna array includes horizontally mounted antennas 100a, 100b, 100c and 100d which respectively produce magnetic interrogation fields 102a, 102b, 102c and 102d in an upward direction. The interrogation fields 102a-102d together define an interrogation zone in which a RFID transponder (not shown) can be read. Each interrogation field partially overlaps the interrogation field from an adjacent antenna so that there are no intervening holes in the interrogation zone in which the transponder cannot be read.

The interrogation zone jointly defined by the interrogation fields 102a-102d spans the entire width (labeled “W” in FIG. 2) of a dock bay door 104. The typical width of a dock bay door is approximately twelve feet. The height (labeled “h” in FIG. 2) of the interrogation zone above each of the antennas 100a-100d in this exemplary embodiment is approximately 2.5 feet, although the height may higher or lower depending on the power level input into the antennas 100a-100d as will be discussed in more detail below. The dimension (labeled “d” in FIG. 3) of each of the antennas 100a-100d in the depth direction of the interrogation zone is approximately (or slightly larger than) 1.5 feet so that the interrogation zone has a depth of approximately the same size. The depth of the interrogation zone is thus large enough to stimulate and read back a transponder passing through the interrogation zone at a speed, for example, of 10 mph. The dimension of the interrogation zone in the depth direction may be increased or decreased by increasing or decreasing the size of the antennas 100a-100d in the depth direction.

The loops of the antennas 100a-100d are positioned either directly below a cross section of the door 104 or (as shown for example in FIG. 3) on one side of the cross-section of the door 104. As illustrated in FIGS. 2-3, the antennas 100a-100d each form a single loop and are arranged in substantially the same plane. This allows the strength of the interrogation zone to be relatively evenly distributed without any holes over the width of the dock bay door 104. The array of antennas 100a-100d overcomes difficulties that would have resulted if a single antenna were implemented to form the interrogation zone. Specifically, if a single antenna having the dimensions necessary to create an interrogation zone over the width of the dock bay door 104 were implemented, its inductance would be so large that it would be virtually impossible to create an impedance matching circuit to offer the proper input impedance and resonant frequency. The single antenna would also have holes in its generated interrogation zone (i.e., volume) near the center of the loop of the single antenna.

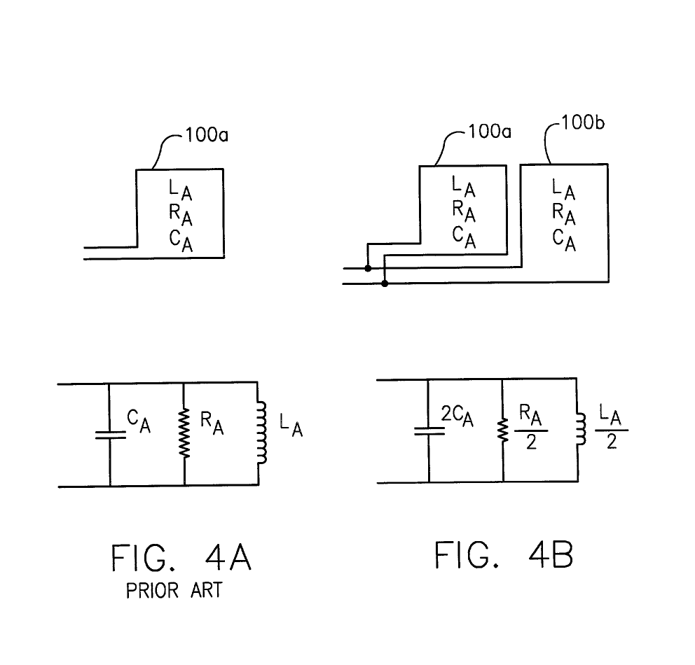

A pair of the antennas 100a, 100b are connected in parallel and have leads that extend from one edge (left edge in FIG. 2) of the dock bay door 104. Another pair of the antennas 100c, 100d are connected in parallel and have leads that extend from the other edge (right edge in FIG. 2) of the dock bay door 104. The pairs of antennas 100a, 100b and 100c, 100d are connected in parallel to reduce their respective equivalent input inductances. FIG. 4B illustrates, for example, an electronic schematic of the lumped elements forming the parallel combination of loop antennas 100a and 100b, each of which has an inductance LA, capacitance CA and resistance RA. The schematic illustrates that the input inductance of the antennas 100a, 100b is reduced to LAI2 by combining the antennas 100a, 100b in parallel. Similar comments apply to the parallel combination of loop antennas 100c and 100d. FIG. 4A illustrates the intrinsic properties, LA, RA and CA, of a conventional loop antenna.

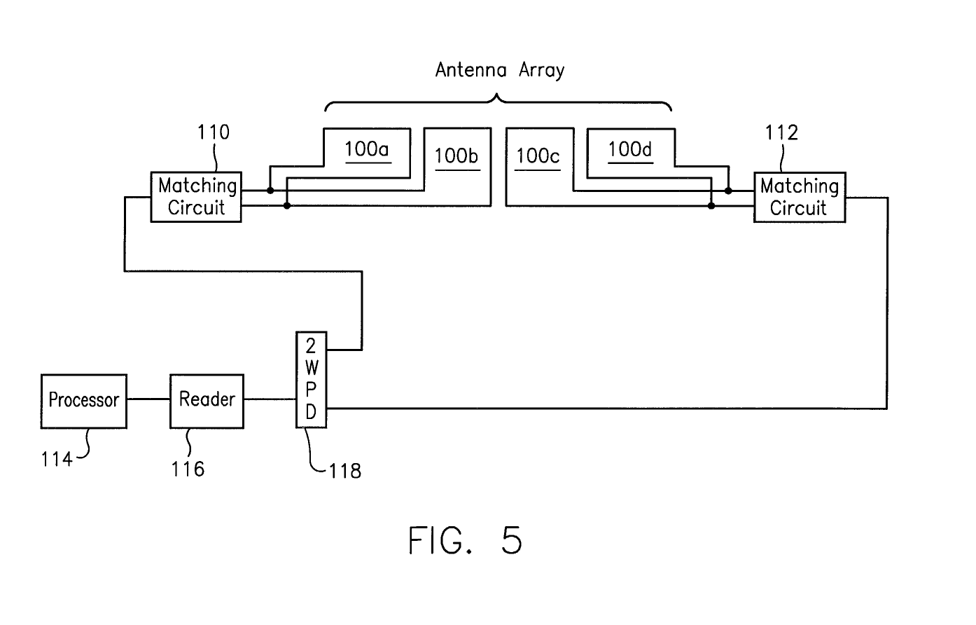

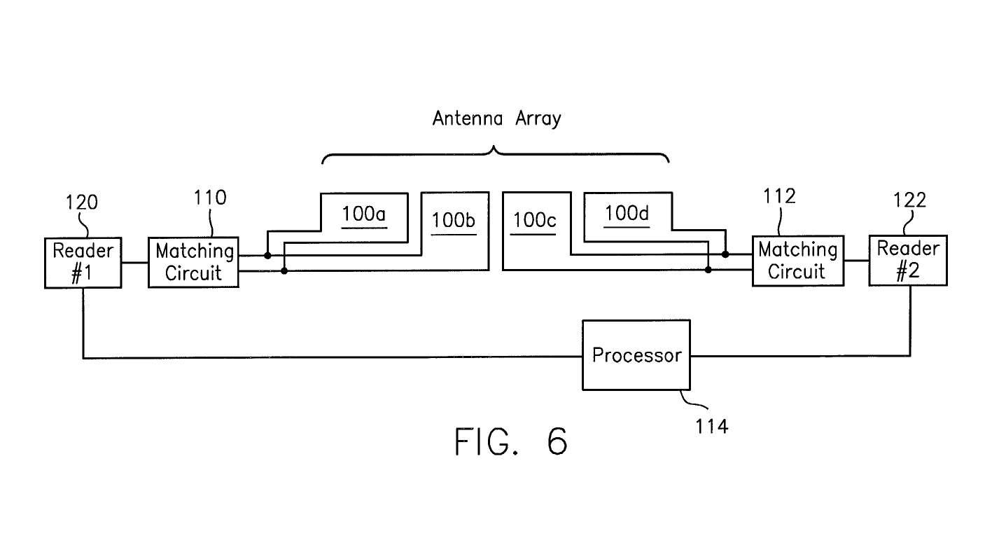

FIGS. 5-6 illustrate the electronic circuitry needed to excite the antennas 100a-100d to produce their respective interrogation fields 102a-102d and receive a coded signal from an RF transponder after being stimulated by the interrogation zone formed by the interrogation fields 102a-102d. The pair of parallel-connected antennas 100a, 100b is connected to an impedance matching circuit 110 and the pair of parallel-connected antennas 100c, 100d is connected to an impedance matching circuit 112. In the exemplary embodiment illustrated in FIG. 5, the antennas 100a-100d are fed with an excitation signal from a single reader 116 through a 2-way power divider 118. The reader 116 is connected to a computer processor 114 which controls the reader 116 and receives signals therefrom. In the alternative exemplary embodiment illustrated in FIG. 6, the matching circuit 110 is connected to a first reader 120 and the matching circuit 112 is connected to a second reader 122. Both of the readers 120,122 are connected to a computer processor =114 which provides signals to the readers 120,122 and receives signals therefrom. The processor 114 treats the feedback received from each reader 120,122 as though it was received from the same checkpoint.

In the exemplary embodiment illustrated in FIG. 5, the output power from the reader 116 provided to each antenna pair to produce the interrogation fields 102a-102d is reduced by approximately 3 dB since the two-way power divider 118 splits the total power provided to the antenna array. Since less power is provided to each antenna pair, the height (dimension “h” in FIG. 2) of the interrogation zone is reduced, for example, to 1.5 feet. To increase the height of the interrogation zone in this situation, the output power provided by the reader 116 may be adjustable. The total power from the reader 116 may thus be doubled (i.e., increased by 3 dB) relative to its normal level since the reader 116 is driving separate antenna pairs. Doubling the power from the reader 116 can be accomplished while maintaining all of the normal emissive requirements.

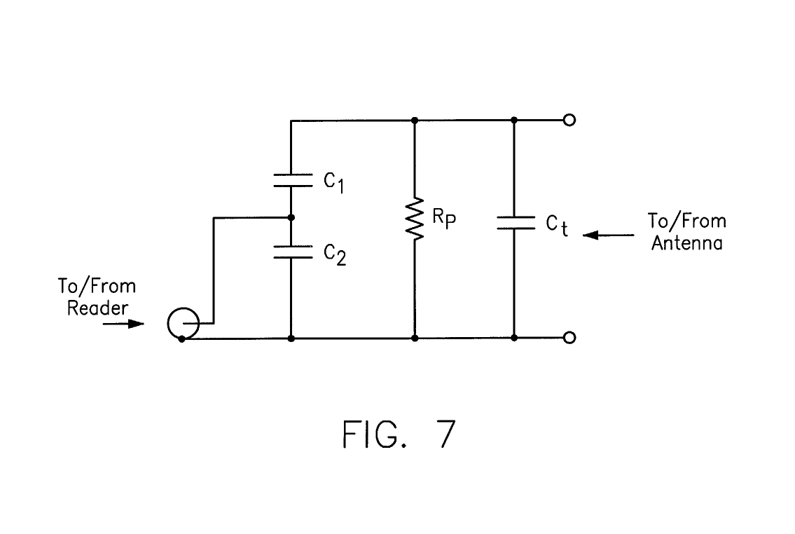

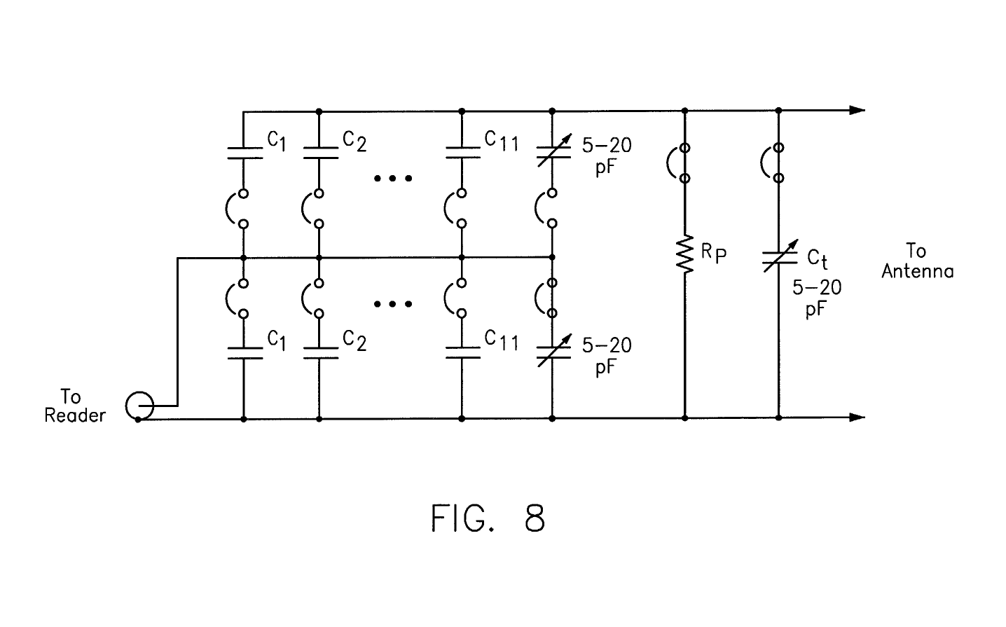

The matching circuits 110,112 match the output impedance of the reader 116 (in the exemplary embodiment of FIG. 5) or the readers 120,122 (in the exemplary embodiment of FIG. 6) with the input impedance of the antennas 100a-100b and 100c-100d. The typical output impedance of a reader is 50 ohms. The matching circuits 110, 112 also insure that the circuit formed by the antenna and matching circuit properly resonates at the carrier frequency of the reader. The frequency is approximately 13.56 MHz to stimulate passive RF transponders. There are several types (e.g., capacitive, transformer, balun, etc.) of matching circuits that may be implemented as the matching circuits 110, 112 implemented in the exemplary embodiments. Two different preferred embodiments of a matching circuit which may be implemented as matching circuit 110 or 112 are illustrated in FIGS. 7 and 8.

In the embodiment illustrated in FIG. 7, the matching circuit includes capacitors C₁, C₂, Cₜ and resistor Rp. A series combination of capacitors C₁ and C₂ are connected in parallel with resistor Rₚ and capacitor Cₜ. The capacitors C₁, C₂ and Cₜ form an equivalent capacitance, which when combined with the inductance and parasitic capacitance of a connected antenna pair, causes resonance at 13.56 MHz. Capacitors C₁ and C₂ are balanced such that, when combined with the lumped elements of the connected antenna pair, the input impedance of the circuit is 50 ohms. The resistor Rp is utilized to set the quality factor Q of the circuit. The Q of the circuit determines the operating bandwidth of the network which is required to pass modulated information encoded on the carrier signal. The resistor Rp and the parasitic resistance of the connected antenna pair therefore determine the passband of the circuit.

The lumped element model of the antenna array is different in free space than when it is mounted on a floor. Therefore, the matching circuit required for the antenna array changes depending upon how the antenna array is mounted. When the antenna array is mounted on the floor, its characteristics remain constant, but different than when it is mounted in free space.

To compensate for the effects of the floor on the antenna array, the matching circuit is reconfigurable. The matching circuits, for example, may be configured so that pressing a button initiates a tuning phase. That is, if a button is pressed, logic circuitry makes measurements over a 5 to 10 second interval to obtain the optimum matching circuit. Alternatively, a manually adjustable tuning circuit, as shown in FIG. 8, may be used to reconfigure the matching circuit to compensate for the effects of the floor on the antenna array. The manually adjustable matching circuit may be adjusted by a knowledgeable user adjusting the capacitance in the matching circuit.

In the exemplary embodiment illustrated in FIG. 8, the matching circuit includes capacitors C₁-C₁₁, resistor Rₚ and capacitor Cₜ. The exemplary capacitance values of C₁-C₁₁ are listed in Table I below. The resistor Rₚ and the capacitor Cₜ are optional and thus may be connected or disconnected through removable jumpers. If the antenna array provides a low enough resistance to provide the proper Q (i.e., provide the proper bandwidth requirements), was the resistor Rₚ may be disconnected. The capacitive balance may be such that the capacitor Cₜ is not required and thus may be disconnected through a removable jumper. The matching circuit, in particular the variable capacitors, may be manually adjusted in accordance with the characteristics of the antenna array which may change when the antenna array is mounted on, within or under a floor.

TABLE 1
Capacitance Values of Capacitors in FIG. 8

| Capacitor | Value [pF] |
|---|---|
| C1 | 5 |
| C2 | 10 |
| C3 | 22 |
| C4 | 33 |
| C5 | 47 |
| C6 | 68 |
| C7 | 100 |
| C8 | 220 |
| C9 | 330 |
| C10 | 470 |
| C11 | 500 |

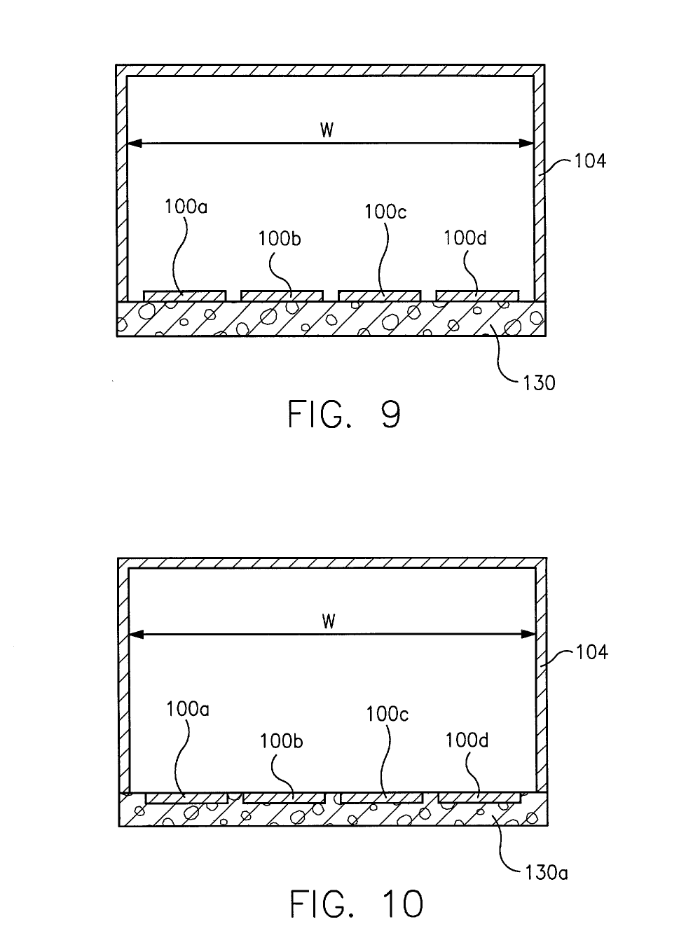

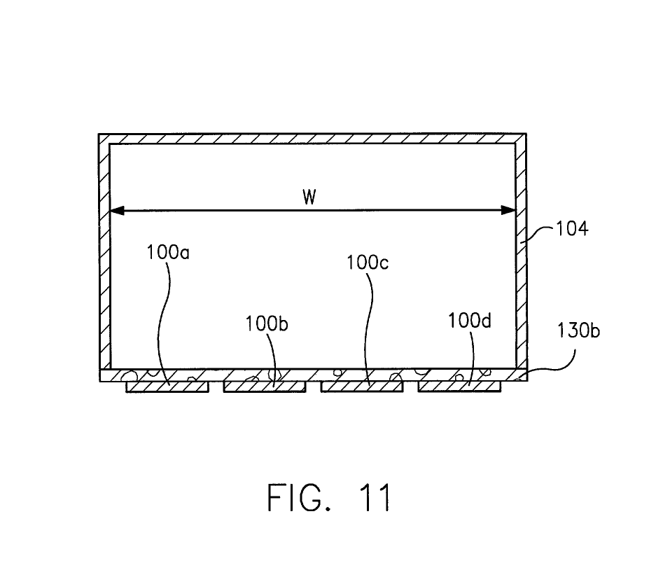

FIGS. 9-11 illustrate various configurations of the antennas 100a-100d with respect to the floor. Specifically, FIG. 9 illustrates antennas 100-100d mounted on a portion of the floor 130, FIG. 10 illustrates antennas 100a-100d mounted within a portion of the floor 130a and FIG. 11 illustrates antennas 100-100d mounted underneath a portion of the floor 130b. Each of the antennas 100a-100d may be made, for example, from thin copper strips that are approximately 1 inch wide. The copper strips are soldered together and positioned adjacent to the door 104. The construction of the antennas 100a-100d is relatively rugged so that a heavy machine such as a tow motor fork or a dragging pallet can be driven directly over the strips of the antennas 100a-100d without causing damage. By mounting the antennas 100a-100d on the surface of the floor (or mounting the antennas 100a-100d on an appropriate floor board) as illustrated in FIG. 9, the height of the interrogation zone may be maximized.

As illustrated in FIG. 10, the antennas 100a-100d may be mounted within a portion of the floor 130a. By mounting the antennas 100a-100d within the floor 103a, the antenna can be protected from damage. Mounting the antennas within the floor 130a is accomplished by, for example, cutting recesses in the floor 130a so that the antennas 100a-100d may be placed therein. The top surface of the antennas 100a-100d will be flush with the floor 130a to insure that the height of the interrogation zone is maximized. By mounting the antennas 100a-100d within the floor, the edges of the antennas 100a-100d can be prevented from being caught on any machine driven through the door 104 such as a tow motor fork or a dragging pallet. Alternatively, the antenna array can be mounted within a large substrate, such as a plexy glass substrate. This substrate (e.g., a six foot section of plexy glass) may be easily moved into a desired location.

FIG. 11 illustrates the antennas 100a-100d mounted underneath a floor 130b. The floor 130b will protect the antennas 100a-100d from physical damage that may be caused by any heavy device passing through the door 104. The floor 130b may be formed, for example, by a section of plexy glass. The floor 130b should, however, be as thin as possible to allow the height of the interrogation zone to be maximized.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An RFID antenna system for providing an interrogation zone, the antenna system comprising:
an antenna array including a plurality of antennas, each of the antennas being substantially coplanar with all of the other antenna(s); and
a circuit operatively coupled to the antenna array for providing a respective signal to each of the antennas of the array to enable each of the antennas to emit an interrogation field;
the interrogation fields emitted from the respective antennas jointly forming an interrogation zone in a volume positioned above each of the antennas.

2. The RFID antenna system of claim 1, wherein at least a first pair of the plurality of antennas are connected in parallel to each other.

3. The RFID antenna system of claim 2, wherein a second pair of the plurality of antennas are connected in parallel to each other.

4. The RFID antenna system of claim 1, wherein the circuit comprises a first impedance matching circuit operatively coupled to a first antenna of the plurality of antennas and a second impedance matching circuit operatively coupled to a second antenna of the plurality of antennas.

5. The RFID antenna system of claim 4, wherein the circuit further comprises a first reader circuit operatively coupled to the first impedance matching circuit for providing an output signal to the first impedance matching circuit and a second reader circuit operatively coupled to the second impedance matching circuit for providing an output signal to the second impedance matching circuit.

6. The RFID antenna system of claim 4, wherein the circuit further comprises a reader circuit operatively coupled to the first impedance matching circuit and the second impedance matching circuit for providing output signals to the first impedance matching circuit and the second impedance matching circuit.

7. The RFID antenna system of claim 3, wherein the circuit comprises a first impedance matching circuit operatively coupled to the first pair of antennas and a second impedance matching circuit operatively coupled to the second pair of antennas.

8. The RFID antenna system of claim 7, wherein the circuit further comprises a first reader circuit operatively coupled to the first impedance matching circuit for providing an output signal to the first impedance matching circuit and a second reader circuit operatively coupled to the second impedance matching circuit for providing an output signal to the second impedance matching circuit.

9. The RFID antenna system of claim 7, wherein the circuit further comprises a reader circuit operatively coupled to the first impedance matching circuit and the second impedance matching circuit for respectively providing output signals to the first impedance matching circuit and the second impedance matching circuit.

10. The RFID antenna system of claim 1, wherein each of the antennas of the antenna array is mounted within a portion of a floor.

11. The RFID antenna system of claim 1, wherein each of the antennas of the antenna array is mounted on a portion of a floor.

12. The RFID antenna system of claim 1, wherein each of the antennas of the antenna array is mounted underneath a portion of a floor.

13. The RFID antenna system of claim 10, wherein a side of at least one of the antennas is flush with a surface of the floor.

14. A method of providing an interrogation zone for an RFID system, the method comprising:
providing an antenna including a plurality of antennas, each of the antennas being substantially coplanar with all of the other antenna(s); and
operatively coupling a circuit to the antenna array for providing a respective signal to each of the antennas of the array to enable each of the antennas to emit an interrogation field;
the interrogation fields emitted from the respective antennas jointly forming an interrogation zone in a volume positioned above each of the antennas.

15. The method of claim 14, further comprising mounting each of the antennas of the antenna array within a portion of a floor.

16. The method of claim 14, further comprising mounting each of the antennas of the antenna array on a portion of a floor.

17. The method of claim 14, further comprising mounting each of the antennas of the antenna array underneath a portion of a floor.

18. The method of claim 15, wherein a side of at least one of the antennas is flush with a surface of the floor.

19. The method of claim 14, further comprising connecting at least a one pair of the plurality of an tennas in parallel to each other.

20. A method of providing an interrogation zone for an RFID system over a width of a door and above a floor, the method comprising:
arranging an antenna array so that each of a plurality of antennas in the array is arranged parallel to the floor; and
operatively coupling a circuit to the antenna array for providing a respective signal to each of the antennas of the array to enable each of the antennas to emit a respective interrogation field;
the interrogation fields emitted from the respective antennas jointly forming the interrogation zone in a volume which is above each of the antennas and the floor.

21. The method of claim 20, wherein each of the antennas of the antenna array is mounted within a portion of the floor.

22. The method of claim 21, wherein at least one of the antenna has a side which is flush with a surface of the floor.

23. The method of claim 20, wherein each of the antennas of the antenna array is mounted on a portion of the floor.

24. The method of claim 20, wherein each of the antennas of the antenna array is mounted underneath a portion of the floor.

25. The method of claim 20, further comprising arranging each of the antennas of the array substantially coplanar with all of the other antenna(s)

26. The method of claim 20, further comprising connecting at least a one pair of the plurality of antennas in parallel to each other.

27. A system comprising:
a floor;
a horizontally mounted antenna array including a plurality of antennas, each of the antennas being mounted parallel to the floor and proximate to the floor; and
a circuit operatively coupled to the antenna array for providing a respective signal to each of the antennas of the array to enable each of the antennas to emit an RFID interrogation field;
the interrogation fields emitted from the respective antennas jointly forming the interrogation zone in a volume positioned above each of the antennas and the floor.

28. The system of claim 27, wherein each of the antennas of the antenna array is mounted within a portion of the floor.

29. The system of claim 28, wherein at least one of the antennas has a side which is flush with a surface of the floor.

30. The system of claim 27, wherein each of the antennas of the antenna array is mounted on a portion of the floor.

31. The system of claim 27, wherein each of the antennas of the antenna array is mounted underneath a portion of the floor.

32. The system of claim 27, wherein each of the antennas is substantially coplanar with all of the other antenna(s) 33. The system of claim 27, wherein at least a one pair of the plurality of antennas is connected in parallel to each other.
